(19) United States
(12) Patent Application Publication
(10) Pub. No.: US 2018/0198291 A1
(43) Pub. Date: Jul. 12, 2018

(54) APPARATUS AND METHOD FOR INTELLIGENT BATTERY OPTIMIZATION AND EQUALIZATION MANAGEMENT SYSTEM

(71) Applicants: Ho-Hsun David Kuo, Peoria, AZ (US); Bingxin Zhao, Long Beach, CA (US); Xiang Meng, Shanghai (CN)

(72) Inventors: Ho-Hsun David Kuo, Peoria, AZ (US); Bingxin Zhao, Long Beach, CA (US); Xiang Meng, Shanghai (CN)

(21) Appl. No.: 15/911,954

(22) Filed: Mar. 5, 2018

Related U.S. Application Data
(63) Continuation-in-part of application No. 14/842,346, filed on Sep. 1, 2015, now Pat. No. 9,912,017.
(60) Provisional application No. 62/139,732, filed on Mar. 29, 2015.
(60) Provisional application No. 62/045,109, filed on Sep. 3, 2014.

(51) Int. Cl. H02J 7/00; H01M 10/44; H01M 2/10; H01M 10/42; H01M 10/0525; B60L 11/18

(52) U.S. Cl. CPC H02J 7/0014; H01M 10/441; H01M 2/1077; H01M 10/4257; B60L 2210/30; H02J 7/0021; B60L 11/1809; H01M 2010/4278; H01M 2220/20; H01M 10/0525

(57) ABSTRACT

An intelligent battery optimization management and equalization system that also monitors all cells within a battery, The system will ensure all cells are charged to maximum capacity, discharges the full capacity of each cell, perform equalization of charges between all the cells, manages and monitors each cell within a battery pack, The system further includes a multi-pulse rectifier transformer to efficiently and reliably convert high voltage AC input from power grids to DC voltage to effectively charge electric vehicles, industrial electrical vehicles, electric buses, portable battery packs, and/or battery-operated vehicles,

### CROSS REFERENCE

This application is a continuation-in-part of and claims priority to U.S. Non-provisional patent application Ser. No. 14/842,346 filed 1 Sep. 2015, which claims priority to U.S. Provisional Patent Application No. 62/045,109 filed 03 Sep. 2014, and U.S. Provisional Patent Application No. 62/139,732 filed 29 Mar. 2015, the specification(s) of which is/are incorporated herein in their entirety by reference.

### FIELD OF THE INVENTION

The invention relates to a system for battery charging, discharging, equalization and management, and a method for its implementation in the technical field of electric vehicles, industrial electrical vehicles, electric buses, portable battery packs, and battery operated vehicles,

### BACKGROUND OF THE INVENTION

A battery is made up of a group of battery cells (referred to as cells). The cells are grouped together in series or in parallel or a combination of both to provide the current and voltage specifications needed to create the battery. The performance of the battery depends on the performance of these cells.

Due to the current manufacturing technology and process, cells from the same assembly line, produced one after another, will not have the exact same specifications or performance. There will always be minor differences. When cells are grouped together, the performance is limited by the weakest cell. The performance of the cells will also deteriorates with age, since the worst cell in a battery deteriorates from a lower starting point than the other cells, it renders the battery obsolete as soon as one cell is near the end of its functional life.

When a battery is being charged, all cells are receiving electrical current and charging at the same time. As soon as one cell has reached its maximum capacity, the charging process will stop for all cells. This happens regardless of the status of the other cells. After a battery is charged, each individual cell is at different capacities from one another. As cells age, the lowest performance cell dominants the performance, the capacity will decrease, resulting in a significant decrease in its capacity to hold a charge.

When a battery is discharging, all cells are discharging at the same time. As soon as one cell is depleted, discharging will stop no matter the capacity of the other cells. This causes a battery to be non-functional even if other cells are still at full or still capable of discharging. A fully charged battery will indicate full charge when tested, that is because the measurement is performed across all cells, within the cells there could be bad cells at lower capacity. With age, the cell performance will decrease and the battery will need to be charged more often and hold less charge,

It is desirable to have an intelligent battery optimization, equalization management system capable of monitoring all battery cells within a battery, ensuring balanced charge/discharge of each cell and performing equalization of charges between all the cells. It is also desirable to apply such an intelligent battery optimization, equalization management system in various fields such as but not limited to electric vehicle charging.

Currently, the power source of large-scale charging facilities in commercial and industrial areas include three-phase AC output terminal of standard distribution transformer which is taken from the public power distribution network, (e.g. Three-phase four-wire power line at 280V or 480V). The current industry practice is to utilize high frequency switching power supplies and inverter technology to transform the public power distribution network into a controllable DC power supply. Due to the cost, technical specification requirements, reliability and the maintainability of the various aspects of the current industry method, the current design adopts many single phase AC and DC power modules to meet the technical requirements of the DC output for charging. However, this type of design includes multiple stages, making the whole design cumbersome, high in cost, taking up a lot of real estate at the installation site, with many fault points making it very hard to maintain. The system wide efficiency is low, and in order to correct the power factor from the three phase power grid, it may be necessary to spend nearly half of the design and material cost in the inverter system to do power factor correction and harmonic control,

The standard three-phase four-wire distribution transformers are not in accordance/specification with the requirements of charging facilities to provide charge to Electric Vehicles or battery packs. To be in accordance/specification with the electric vehicle charging requirements, the source (e.g. three-phase four-wire standard AC) must conduct a variety of power transformations, to not cause harmonic interference to the power grid, contains active and or passive power factor correction devices and to be isolated per the safety requirements for charging an Electric Vehicle or portable battery pack. All of these requirements adds cost and real estate to the installation area.

### SUMMARY OF THE INVENTION

Embodiments of the invention relate to a battery optimization, equalization management system to extend the life of a battery pack and its application for in various fields such as but not limited to residential, commercial, industrial, recreational and electric vehicle charging.

In some embodiments, the present invention provides for an electric vehicle charging system that not only completely removes the front-end standard distribution transformers, but also designs the transformer specifically to meet the charging facilities specifications. The present invention presents a lower cost and more efficient design to construct a charging station to charge Electric Vehicles and battery packs. The charging system of the present invention utilizes a high voltage AC directly from the power lines, with a filter and a low cost dedicated multi-pulse rectifier transformer to form a DC source that is isolated from the power grid and meet the harmonic control requirements, standards and specifications for charging electric vehicles.

In some aspects, a battery management system to provide optimization and equalization management for a battery containing a plurality of individual battery cells is provided. As will be disclosed herein, the system may include a plurality of battery cell controllers each comprising a controllable switch, with each battery cell controller electrically and conductively coupled to an individual battery cell via the controllable switch, a master controller, electrically and conductively coupled to each of the plurality of battery cell controllers for performing one or more of charging, discharging, optimization, and equalization of the plurality of individual battery cells. The system may further include a power source operatively coupled to the master controller for supplying a charging current to the plurality of individual battery cells via the plurality of battery cell controllers, and a load operatively coupled to the master controller for receiving electrical energy from the plurality of individual battery cells. Each battery cell controller may measure a charge level of the individual battery cell to which it is coupled and transmit said measures to the master controller, wherein if the master controller determines that the individual battery cell is at full capacity based on the charge level, then the charging current may be shunted away from the individual battery cell or a trickle charging is provided to the individual battery cell to maintain the charge level at full capacity. The trickle charging may be implemented by controlling an ON/OFF duty cycle of the controllable switch to supply a desired trickle charging current to the individual battery cell determined to be at full capacity.

In some embodiments, power source may include a power grid and the load may include an electric vehicle, an industrial electric vehicle, an electric bus, a portable battery pack, and/or a battery operated vehicle. The master controller may be further coupled to a converter that converts high voltage AC output from the power grid into a DC voltage for charging the plurality of individual battery cells to sufficiently charge the load , wherein the converter may include a filter and a multi-phase rectifier transformer for reliably and efficiently converting the high voltage AC into the DC voltage, which may be subsequently used to charge the electric vehicle, industrial electric vehicle, electric bus, portable battery pack, and/or battery operated vehicle.

In some embodiments, the filter may include an inductor-capacitor (“LC”) filter, wherein inductor and capacitor components of the LC filter may be targeted to eliminate a specific number of harmonics and resonance frequencies of the power grid. In some embodiments, the multi-phase rectifier transformer may be coupled to a multi-pulse rectifier, wherein the multi-phase rectifier transformer converts the high voltage AC into a multi-phase AC, and wherein the multi-pulse rectifier that converts the multi-phase AC into the DC voltage. The multi-phase rectifier transformer may include a six-phase, nine-phase, or twelve-phase transformer coupled to respective twelve-pulse, eighteen-pulse, or twenty-four-pulse rectifier.

In some embodiments, the individual battery cell may be a Lithium battery cell, Lithium-ion battery cell, Lithium polymer battery cell, electrolytic battery cell or electrochemical battery cell. The master controller may receive an input from each battery cell controller and generates an output for each battery cell controller based at least on the input from each battery cell controller. The input from each battery cell controller may include at least one of a voltage across the electrically and conductively coupled individual battery cell, a current through the electrically and conductively coupled individual battery cell and a temperature of the electrically and conductively coupled individual battery cell. The master controller may generate an output for each battery cell controller based on a comparison between the voltage across each electrically and conductively coupled individual battery cell and a first voltage range. Additionally or alternatively, the master controller may generate an output for each battery cell controller based on a comparison between the temperature of the electrically and conductively coupled individual battery cell and a temperature range. Additionally or alternatively, the master controller may generate an output for each battery cell controller further based on a comparison between the voltages across each individual battery cell and an average voltage of the plurality battery cells.

In some embodiments, the charging current may be shunted away from the individual battery cell determined to be at full capacity by switching OFF the controllable switch coupled to the individual battery cell determined to be at full capacity. Additionally or alternatively, when the plurality of battery cells may not be at full capacity, being charged, or discharging, the mater controller may communicate with each battery cell controller to perform equalization of the charge level of the plurality of battery cells to a common charge level, wherein trickle charging maintains the charge level of each battery cell at the common charge level.

In some aspects, the present invention discloses a rechargeable battery pack comprising a plurality of individual battery cells, a plurality of battery cell controllers, each battery cell controller coupling to an individual battery cell, a master controller coupling a power source and a load to each of the plurality of battery cell controllers. Each battery cell controller may be controlled by the master controller to engage or disengage each coupled individual battery cell. The power source may be a power grid, and the master controller may couple the power grid to each of the plurality of battery cell controllers via a converter wherein the converter converts high voltage AC input from the power grid to DC voltage. The converter may include a filter that removes harmonic interference from the high voltage AC input and may further include a multi-phase rectifier transformer that efficiently and reliably converts filtered high voltage AC into the DC voltage for charging the rechargeable battery pack.

In some embodiments, the filter may be downstream of the power grid and upstream of the multi-phase rectifier transformer and wherein the filter may include an inductor-capacitor (“LC”) filter, wherein inductor and capacitor components of the LC filter may be targeted to eliminate a specific number of harmonics and resonance frequencies of the power grid. The multi-phase rectifier transformer may be coupled to a multi-pulse rectifier, wherein the multi-phase rectifier transformer converts the high voltage AC into a multi-phase AC, and wherein the multi-pulse rectifier that converts the multi-phase AC into the DC voltage. The multi-phase rectifier transformer may include a six-phase, nine-phase, or twelve-phase transformer coupled to respective twelve-pulse, eighteen-pulse, or twenty-four-pulse rectifier.

In some aspects, the present invention discloses a cost-effective electric vehicle charging system for reliably and efficiently charging an electric vehicle. The system may include a converter coupling a power grid to the electric vehicle, the converter having an inductor-capacitor (“LC”) filter, a multi-phase rectifier transformer, and a multi-pulse rectifier that effectively filters and reduces harmonics from the power grid and further converts high voltage input AC voltage into DC voltage. The system may include a DC charger coupled to the converter that receives the DC voltage and applies the DC voltage to the electric vehicle for charging the electric vehicle, wherein inductor and capacitor components of the LC filter may be targeted to eliminate a specific number of harmonics and resonance frequencies of the power grid, to effectively reduce harmonic pollution from the high voltage AC voltage of the power grid. The multi-phase rectifier transformer may include a six-phase, nine-phase, or twelve-phase transformer coupled to respective twelve-pulse, eighteen-pulse, or twenty-four-pulse rectifier.

In some embodiments, the system may further include a rechargeable battery pack, wherein the rechargeable battery pack includes a plurality of individual battery cell, a plurality of battery cell controllers, a master controller, wherein each battery cell controller couples the master controller to each individual battery cell, and wherein the master controller couples the power grid to each individual battery cell through the converter to efficiently charge each individual battery cell and further couples each individual battery cell to the electric vehicle for reliably supplying electric energy from each individual battery cell to the electric vehicle for subsequently charging the electric vehicle.

Some aspects of the present invention provide for a low-cost, highly reliable, and efficient electric vehicle charging system. One of the unique and inventive technical features of the present invention is the inclusion of a filter upstream of a multi-phase rectifier transformer in the charging system that is coupled directly to the power grid. The filter that is coupled to the power grid reduces harmonic pollution of public power grids while providing isolation, voltage level transformation, and multi-voltage phase change. Herein, the filter may comprise an LC filter whose components are specifically chosen to eliminate harmonics and resonance frequencies of the power grid, and said LC filter can be used to meet government and/or design specifications. Without wishing to limit the invention to any theory or mechanism, by utilizing the LC filter, the filtering and isolation effect of the system is greatly enhanced. In some example embodiments, the LC filter may be arranged in multiple to target various frequencies. By targeting various frequencies, the charging system may be used across multiple countries having different frequencies (60 Hz, 50 Hz), for example.

The multi-pulse rectifier transformer may be a six phase transformer, however, the design may be increased to nine phase, twelve phase, and the like to further lower the harmonic interference, for example. Herein, the output of the multi-phase transformer may be directly tied into a multiple-pulse rectifier, which is a fail-safe design with almost no maintenance needed. Without using any additional components, the multi-phase rectifier transformer provides a power factor correction and reduces the harmonic interference drastically. Without wishing to limit the invention to any theory or mechanism, it is believed that the technical feature of the present invention advantageously provides for a charging system that achieves higher efficiency, significantly reduces manufacturing and maintenance costs, and is more reliable. None of the presently known prior references or work has the unique inventive technical feature of the present invention.

### BRIEF DESCRIPTION OF THE DRAWINGS

Reference will be made to exemplary embodiments of the present invention that are illustrated in the accompanying figures. Those figures are intended to be illustrative, rather than limiting. Although the present invention is generally described in the context of those embodiments, it is not intended by so doing to limit the scope of the present invention to the particular features of the embodiments depicted and described.

FIG. 1 is an exemplary block diagram of an illustrative battery optimization, equalization management system (BOEMS) for a rechargeable battery pack in accordance with an embodiment of the present invention.

FIG. 2 shows an illustrative discharge characteristic curve for an exemplary 3.7-volt lithium ion cell at 25° C., compared with the same cells with BOEMS and BOEMS with equalization.

FIG. 3 shows an illustrative flow diagram for controlled charging of a battery pack in accordance with an embodiment of the present invention.

FIG. 4 shows an illustrative flow diagram for controlled equalization of a battery pack in accordance with an embodiment of the present invention.

FIG. 5 shows an illustrative flow diagram for controlled discharging of a battery pack in accordance with an embodiment of the present invention.

FIG. 6 shows a block diagram of a battery optimization, equalization management system (BOEMS) for a rechargeable battery pack used for a mobile charging apparatus for electric vehicles.

FIG. 7 is a perspective view of a mobile charging apparatus in accordance with an embodiment of the present invention.

FIG. 8 is a front view of a mobile charging apparatus of FIG. 7.

FIG. 9A is a schematic diagram of an industry-standard charging station.

FIG. 9B is a high level schematic of the industry-standard charging station.

FIG. 10A is a schematic diagram on a non-limiting embodiment of a charging system.

FIG. 10B is a high level schematic of the non-limiting embodiment of the charging station.

One skilled in the art will recognize that various implementations and embodiments may be practiced in line with the specification. All of these implementations and embodiments are intended to be included within the scope of the invention.

### DESCRIPTION OF PREFERRED EMBODIMENTS

In the following description, for the purpose of explanation, specific details are set forth in order to provide an understanding of the present invention. The present invention may, however, be practiced without some or all of these details. The embodiments of the present invention described below may be incorporated into a number of different means, components, circuits, devices, and systems. Devices shown in block diagram are illustrative of exemplary embodiments of the present invention. Connections between components or devices within the figures are not intended to be limited to direct connections. Instead, connections between components may be modified, re-formatted via intermediary components.

When the specification makes reference to “one embodiment” or to “an embodiment”, it is intended to mean that a particular feature, structure, characteristic, or function described in connection with the embodiment being discussed is included in at least one contemplated embodiment of the present invention. Thus, the appearance of the phrase, “in one embodiment,” in different places in the specification does not constitute a plurality of references to a single embodiment of the present invention.

Following is a list of elements corresponding to a particular element referred to herein:
10 battery pack
12 battery cells
14 cell sensor
16 arrow
20 cell controller
22 switch
30 master controller
32 power source
34 load
36 converter
600 power grid
610 charging interface
620 battery optimization equalization management system (BOEMS)
630 batteries
640 information indicator
650 system management
660 communications array
670 discharge interface
680 electric vehicles
690 mobile charging apparatus
700 extendable handle
710 information indicator
720 charging apparatus
730 wheels
740 stopper
750 electric vehicle
760 bump projection
770 extension bar
900 charging station
902 power grid
904 transformer
906 converter
908, 910, 912 chargers
914 charge bus
916 battery packs
918 electric vehicle
924 filter
926 rectifier
928 filter
930 transformer
932 rectifier
934 filter
936 DC output
950 schematic
1000 charging station
1002 filter
1004 multi-phase rectifier transformer
1006 multi-pulse rectifier
1008 DC charger
1010 converter

Various embodiments of the invention are used for a battery optimization, equalization management system to extend the life of a battery pack and its application for in various fields such as but not limited to residential, commercial, industrial, recreational and electric vehicle charging.

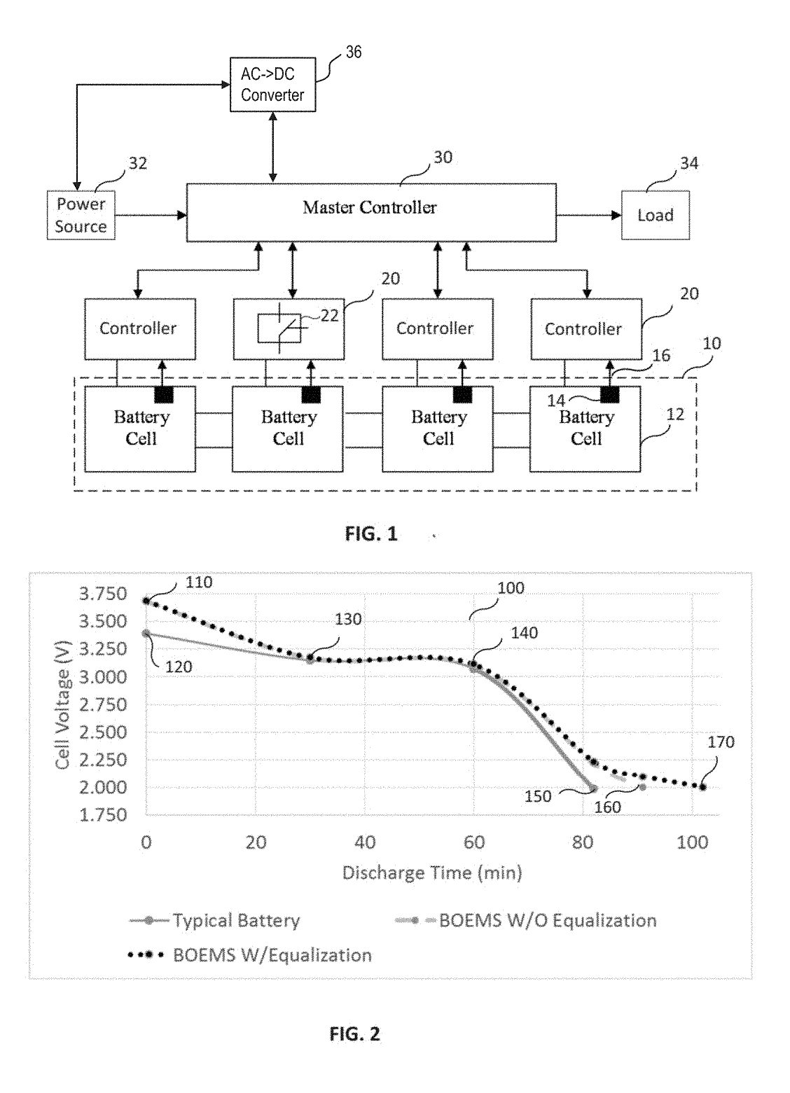

FIG. 1 shows an exemplary block diagram of an illustrative battery optimization, equalization management system (BOEMS) for a rechargeable battery pack in accordance with an embodiment of the present invention. The battery pack 10, includes a plurality of battery cells 12, with each battery cell couples to a dedicated battery cell controller (and monitor) 20. The plurality battery cells 12 may be connected together in series, parallel or a combination of series/parallel connection to form the battery pack 10. The battery cells 12 may be a Lithium battery cell, Lithium-ion battery cell, Lithium polymer battery cell, electrolytic battery cell, electrochemical battery cell or any energy storage device. In some embodiments, the individual rechargeable battery cell 12 is a cell package comprising multiple battery elements.

A master controller 30 couples to all the battery cell controllers 20. In one embodiment, the master controller 30 couples to a power source for battery charging. The master controller 30 may also couple to a load 34 to provide energy (battery discharging). The master controller 30 controls all charging, discharging, optimizing, protect and equalizing functions of the battery pack.

In one embodiment, the battery cell 12 may have a cell sensor 14, which measures at least one parameter of the battery cell 12 and sends the measured at least one parameter to corresponding cell controller 20. The cell sensor 14 may be a voltage sensor measuring voltage cross the cell, a current sensor measuring current through the cell, a temperature sensor measuring the cell temperature during operation, or a combination of multiple sensors. The cell controller 20 receives at least one parameter from the cell sensor 14 and sends the information (arrow 16) to the master controller 30, which controls the charging, discharging, optimizing, and equalizing functions for all the battery cells 12 via the cell controller 20 based at least on one parameter from the cell sensor 14. In an alternative embodiment, the cell controller 20 may also make controls of charging, discharging, optimizing, and equalizing functions for all the battery cells 12 in various situations, such as when the master controller 30 does not provide controls to the cell controller 20 over a predetermined time period, or when the master controller 30 sends an error message to the cell controller 20, etc.

In one embodiment, the cell controller 20 comprise a controllable switch 22, which is configured to receive controls from the master controller 30 to electrically engage/disengage the corresponding battery cell 12 from the power source 32 or the load 34 for the control of battery cell charging/discharging. The controllable switch 22 may be a semiconductor switch (such as a SCR or a thyristor switch) or a relay controlled switch. The battery cell 12 maybe any type of rechargeable battery cell, such as an electrochemical battery cell, a lithium battery cell, a super capacitor cell, etc.

The battery cell controller 20 couples between the battery cell 12 and the master controller 30. The battery cell controller 20 provides information of each individual battery cell 12, such as voltage, current and temperature, to the master controller 30.

The master controller 30 collects all information received from the battery cell controller 20 and provides control signals to each battery cell controller 20 for engagement/disengagement of each corresponding battery cell 12. The engagement/disengagement of each corresponding battery cell 12 may be parallel, independent from each other or in a certain order. In some embodiments, the master controller 30 may also provide the collected information to a requester for additional local or remote monitoring/controlling.

In some embodiments, all the battery cell controllers 20 and the master controller 30 are integrated together into a single controlling component. This will reduce cost for the hardware and also simplify installation.

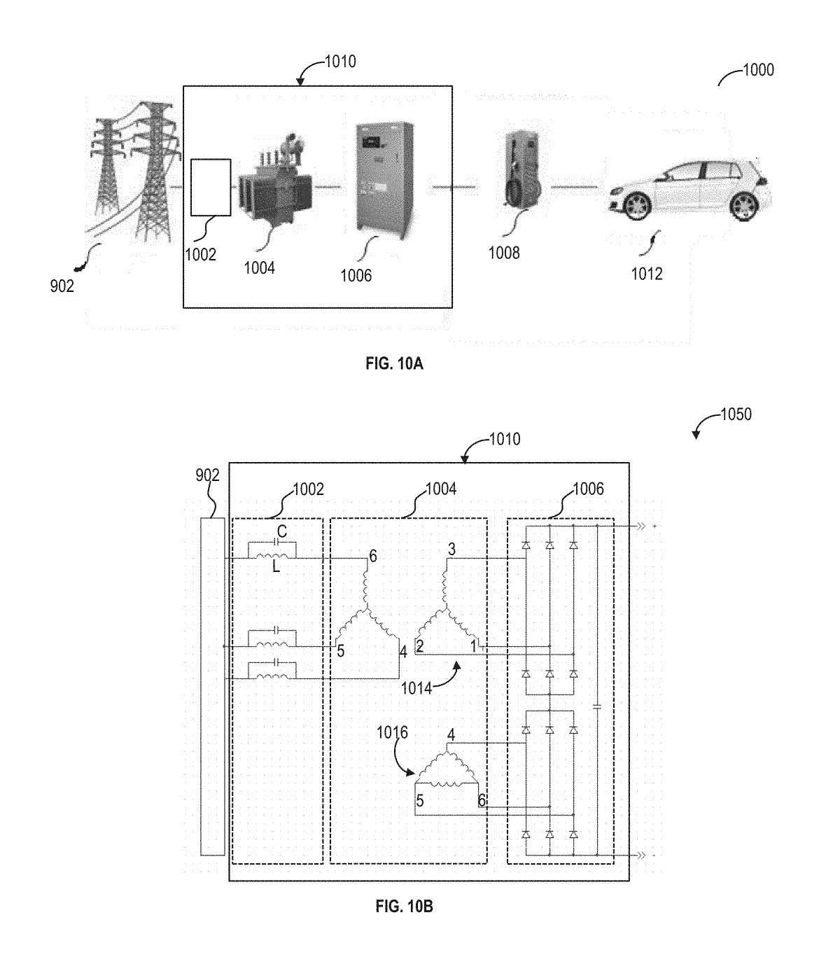

In some embodiments, the BOEMS system may be used for charging electric vehicles, industrial electric vehicles, electric buses, portable battery packs, and battery operated vehicles. In such embodiments, the power source 32 may be a power grid, and an AC-DC converter 36 may be coupled to the power source 32 to convert the high voltage AC to low voltage AC and further to DC voltage, as shown further below in FIGS. 10A and 10B. Briefly, the AC-DC converter 36 may include a first stage LC filter and a multi-phase rectifier transformer that provides low harmonic rectification, electrical isolation and voltage level transformation in a cost effective and reliable manner, as discussed further below with reference to FIGS. 10A and 10B.

Turning now to FIG. 2, FIG. 2 shows an illustrative discharge characteristic curve for an exemplary 3.7-volt lithium ion pack with multiple cells at 25° C., compared with the same pack with BOEMS and BOEMS with equalization 100. As shown, the fully charged battery pack without BOEMS is fully charged at around 3.4V 120. The battery pack with BOEMS are fully charged at 3.7V 110. The present invention is capable of optimizing the battery pack to be charged to its maximum potential at 3.7V. As the battery pack discharges, the operating voltage drops to around 32V 130, where it remains constant for most of the discharge cycle. Near the end of the discharge cycle 140, the operating voltage of the battery pack drops sharply until the minimum operational voltage is reached and the battery stops discharging 150. The battery with the BOEMS, but without equalization is able to discharge further, offering an 11% increase in discharge time 160. Utilizing the BOEM to its full capability with battery cell equalization, the discharge time has increased by 24% 170. As a battery ages, the performance will drop, and the improvements with BOEMS will be greater.

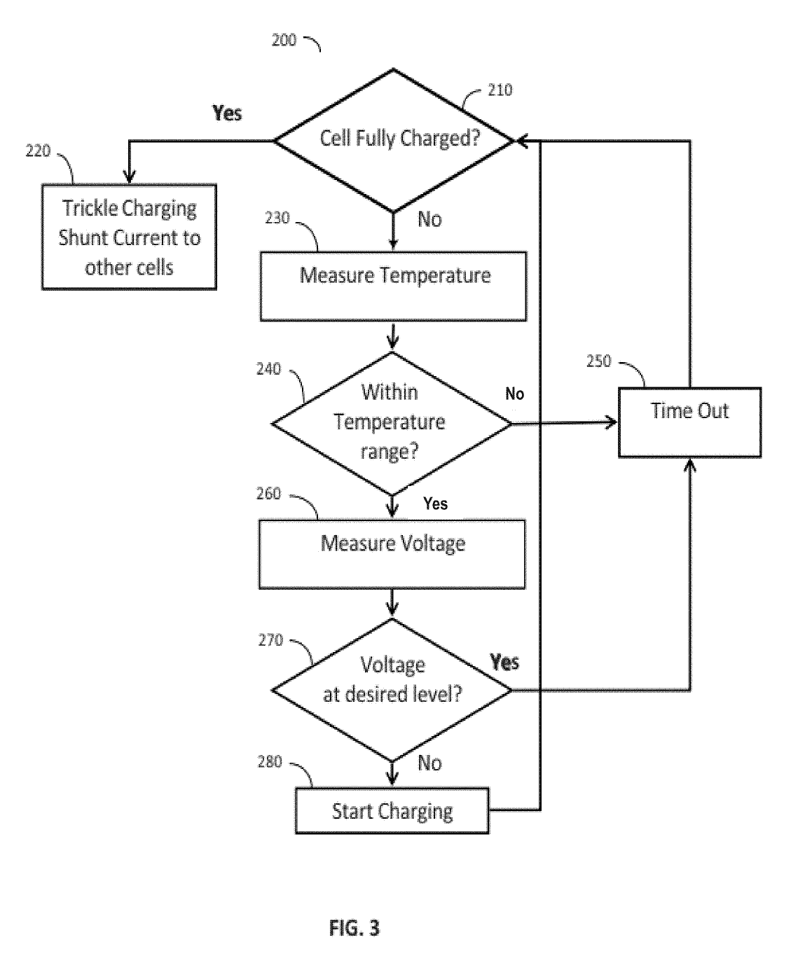

FIG. 3 shows a flow diagram of an illustrative embodiment of a method 200 for controlled charging of a battery cell 12 of a battery pack 10 of the present invention. The controlled charging method 200 for a battery cell 12 starts at step 210 by making measurements and checking if the battery cell 12 is at full capacity. If the battery cell 12 is determined to be at full capacity, then trickle charging for this battery cell 12 will be initiated at step 220 to keep the battery cell 12 at full capacity while waiting for other battery cells to reach maximum potential. Charging current is shunt away from this battery cell 12, to decrease charging time for other battery cells. In one embodiment, the trickle charging may be implemented by controlling the ON/OFF duty cycle of the controllable switch 22 for a desired trickle charging current. Current shunting may also be implemented by switching OFF the corresponding controllable switch 22 related to the battery cell 12.

If the battery cell 12 is not fully charged, a measurement of the temperature of the battery cell 12 is taken at step 230. The temperature measurement is compared to a preset temperature range at step 240 to determine if an over or under temperature situation is occurring. If an over or under temperature is determined, the temperature is considered to not be within the temperature range the battery cell 12 is be place in time out and stops charging 250, with pre-determined time settings then repeat the process at 210 making measurements on the voltage charge of the battery cell 12. If the temperature 230 of the battery cell 12 is within acceptable range, the voltage 260 across the battery cell 12 is measured.

The voltage across the battery cell 12 is measured in step 260 and compared to a preset voltage range between an upper limit and a lower limit (with the upper limit higher than or equal to the lower limit) in step 270 to determine if the measured voltage is at a desired maximum capacity level. If the maximum capacity level is reached, then the battery cell 12 is placed in time out mode (stop charging) in step 250. After a pre-determined time interval setting, the process is repeated at step 210 to make measurements on the charge of the battery cell 12. If the measured voltage is lower than the lower limit, then charging starts again in step 280. Charging 280 will resume for a pre-set amount of time, then will restart the process back at 210 making measurements on the charge of the battery cell 12.

This method 200 resumes until all battery cells within the battery pack 10 are fully charged and under trickle charging status in step 220. In some embodiment, the method 200 may also be initiated where temperature of battery cell 12 is constantly monitored and compared to the preset temperature range.

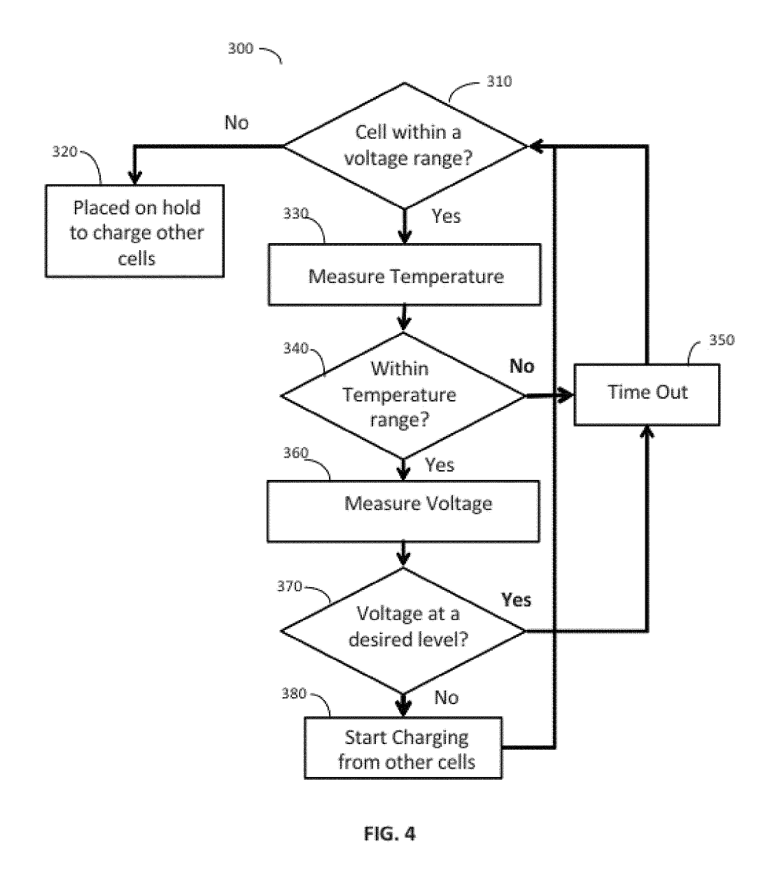

FIG. 4 shows a flow diagram of an illustrative embodiment of a method 300 for controlled equalization of battery cells 12 of a battery pack 10 of the present invention, when no charger is connected. Equalization utilizes the variance in stored energy in each battery cell 12 to charge each other to reach equalization among battery cells and is constantly in operation to maintain the equalization among all battery cell voltage values. The method 300 starts at step 310 by making measurements and checking whether the battery cells 12 are within the preset voltage range of one another. If a battery cell 12 is determined to be over voltage (above an upper limit of the preset voltage range), the battery cell 12 is placed on hold for a preset time while waiting for other cells to equalize and to be used to charge other battery cells 12.

If the battery cell 12 is within the voltage range, a measurement of the battery cell temperature is taken at step 330. The measured temperature is compared to a preset temperature range at step 340 to determine whether an over or under temperature situation is occurring, the temperature is considered to not be within the temperature range. If the temperature is not within the preset temperature range, the battery cell 12 is place in time out mode and stops charging (if charging was initiated) in step 350. After a pre-determined time interval, the process is repeated at step 310 making measurements on the voltage of the battery cell 12. If the temperature of the battery cell 12 is within an acceptable range, the voltage across the battery cell 12 is measured in step 360.

The voltage across the battery cell 12 is compared to an average battery cell voltage value in step 370 to determine whether the voltage the battery cell 12 is at the desired equalization level. The average battery cell voltage value is calculated based on measured voltage values from all battery cells, If the equalization level is reached, then the battery cell 12 will be placed in time out mode and stops charging (if charging was initiated) in step 350, After a pre-determined time interval, the process is repeated at step 310 to make measurements again on the charge of the battery cell 12. If the measured battery cell voltage is lower than the average battery cell voltage values, the battery cell 12 starts charging process in step 380. After a pre-set amount of charging time, the process goes back to step 310 for another round of measurements on the battery cell 12.

After all battery cells 12 are fully equalized, the process goes on hold in step 320. In one embodiment, this method 300 may utilize the situation when the charger is still connected but all battery cells 12 are in trickle charging status 220 to further ensure each battery cell 12 has reached equalization among battery cells 12 and is constantly in operation to maintain the equalization among all battery cell voltage values.

In some embodiment, the method 300 may also be operated only during a desired time period. This method 300 may also be initiated with temperature of the battery cells being constantly monitored and compared to a preset temperature range.

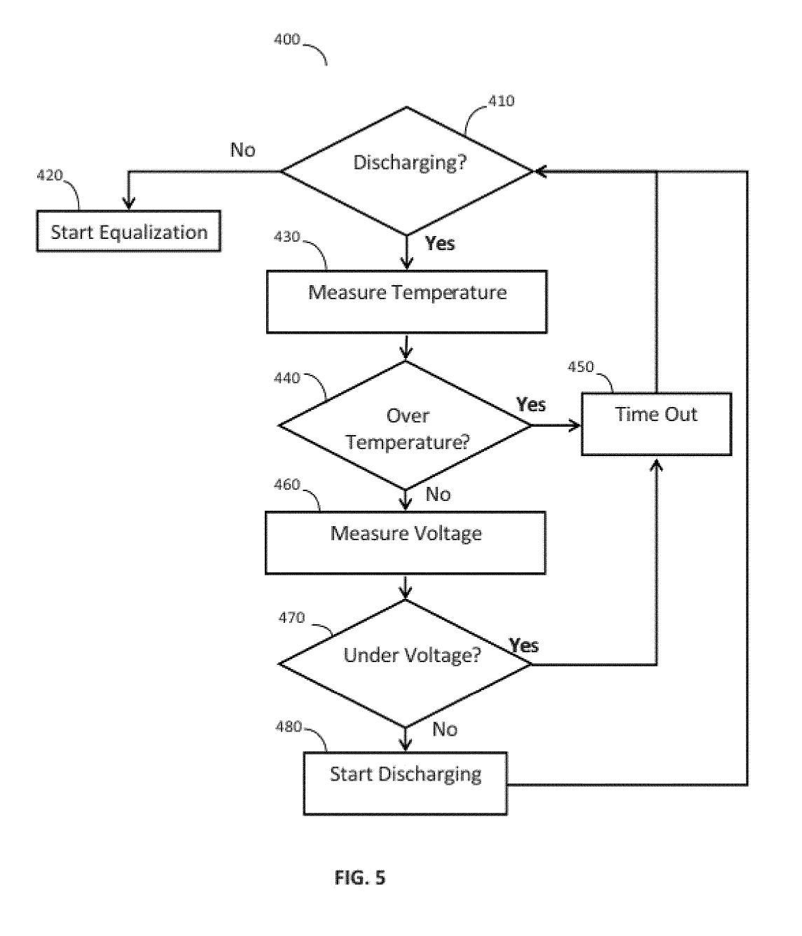

FIG. 5 shows a flow diagram of an illustrative embodiment of a method 400 for controlled discharging of a battery cell 12 of a battery pack 10 of the present invention. The method 400 starts at step 410 by checking if there is a load and the battery cell 12 is to be discharging. If the battery cell 12 is determined to be not discharging or not needed to be discharging, then process goes to step 420 for equalization as described in FIG. 4.

If the battery cell 12 is to be discharging, a measurement of the battery cell 12 temperature is taken at step 430. The measured temperature is compared to a preset temperature range at step 440 to determine if an over or under temperature situation is occurring. If an over or under temperature is determined, the temperature is considered to not be within the temperature range, the battery cell 12 is placed in time out mode and stops discharging (if discharging was initiated) at step 450. After a pre-determined time interval, the process is repeated at step 410 to check whether the battery cell 12 is ready for discharging. If the temperature of the battery cell 12 is within the preset temperature range, the voltage across the battery cell 12 is measured at step 460.

The measured voltage across the battery cell is compared to a preset voltage range at step 470 to determine if the battery cell 12 is under voltage (below a lower limit of the present voltage range). If yes, the battery cell 12 is placed in time out mode and stops discharging (if discharging was initiated) in step 450. After a pre-determined time interval, the process is repeated at step 410 to start equalization, as described in method. If the measured voltage is higher than the preset voltage value, the battery cell 12 starts discharging at step 480. After discharging for a pre-set amount of time, the process goes back to step 410 and start equalization at step 420, as described in method 300.

In some embodiments, the method 400 resumes until all battery cells are discharged to a level that the battery pack 10 can no longer provide discharge to the load 34. In some embodiments, the method 400 may also be implemented with battery cell temperature 430 being constantly monitored and compared to the preset temperature range. In some embodiments, the method 400 resumes and assigns each under voltage cell at step 470 to be fully discharged and continue method 400 until all cells are considered depleted and fully discharged, In some embodiments, method 400 continues in parallel as method 300 to ensure all cells depletes at the same time.

The advantages of the present invention include without limitation, the ability to increase battery life, increase battery performance, increase discharge time, increase safety and prevent battery fires. This capability is crucial for commercial and industrial battery packs where storage is in the Kilo Watt Hour (KWh) range.

It would be desirable to apply such an intelligent battery optimization, equalization management system in various fields such being utilized as a charging station for electric vehicle charging, backup power sources, time of use power sources utilizing lower utility cost during the night and using this stored energy during the day at peak hours for industrial, commercial and residential purposes.

A charging station for electric vehicles is a crucial element in an infrastructure that supplies electrical energy for the recharging of, but not limited to plug-in electric vehicles, battery electric vehicles, neighborhood electric vehicles and plug-in hybrid electric vehicles.

Charging stations for electric vehicles in developed countries may not need new infrastructure. The charging stations can utilize the existing electrical grid and the residential infrastructure is capable of handling the load of an electric vehicle. The requirements for the installation of an electric vehicle charger for commercial and industrial areas are enough room to position the charger, transformer, and enough room to park the electric vehicle for charging. For residential areas the electric vehicle owner simply needs a garage or parking area with access to 220 volt or 110 volt, where an Electric Vehicle Supply Equipment can obtain power.

In order to offer charging for electric vehicles in commercial areas the business owner will have to purchase electric vehicle chargers and pay for the installation of the charger on the property. Depending on the existing wiring for the business, the cost can be very significant and does not justify for a business case with high enough return to break even or profitable to support electric vehicles.

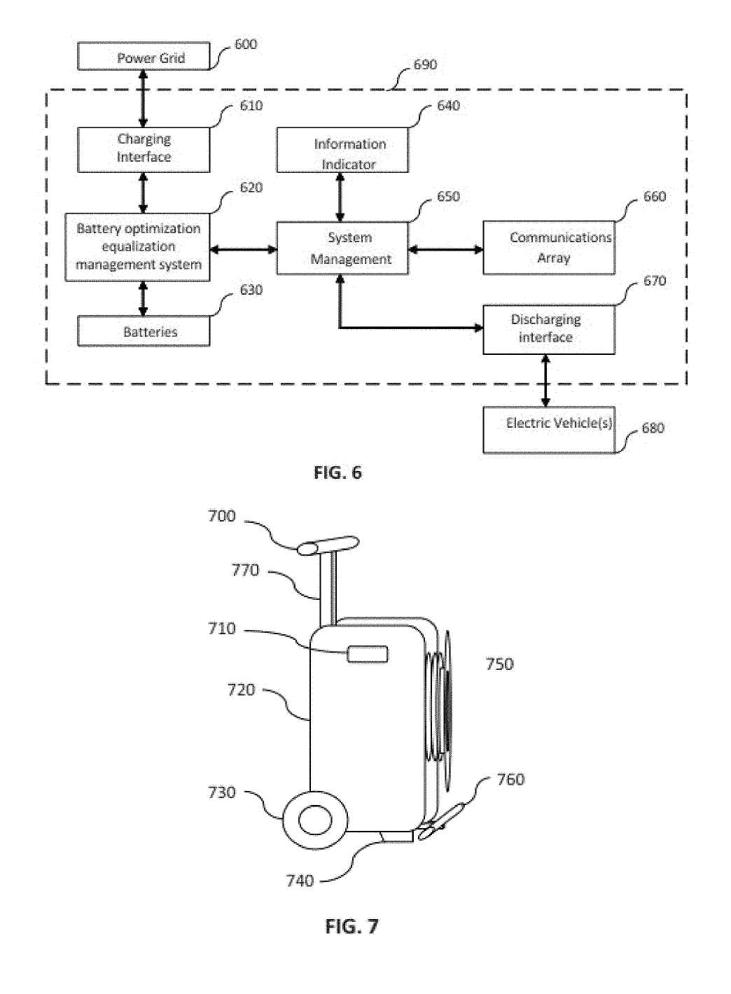

FIG. 6 shows a block diagram of a battery optimization, equalization management system (BOEMS) for a rechargeable battery pack used for a mobile charging apparatus for a load such as electric vehicles. The mobile charging apparatus 690 for electric vehicles where the charging infrastructure is not available or a range extension for the electric vehicle 680 is needed. The system may receive electricity from the power grid 600 and connect to the mobile charging apparatus 690 thru a charging interface 610 via a cable or connection to the AC outlet tied to an electric power source such as power grid 600 or an electric charger tied to the power grid 600. In some non-limiting embodiments, the charging interface may include a converter (as shown in FIGS. 10A and 10B) having a multi-phase rectifier transformer to convert the high voltage AC from the power grid 600 to DC, as explained further below.

The system may comprise an on board battery optimization equalization management system 620 that monitors the electricity from the charging interface 610, monitors the batteries 630 that stores the electric charge and may convert the AC input from the charging interface 610 to DC to be stored into the batteries 630. The size and storage capacity of the batteries 630 varies depending on the storage capacity, material of the batteries 630 and charge rate needed to the electric vehicles 680. In some embodiments, the batteries 630 is a battery pack comprising a plurality of battery cells. The battery cells may be connected in parallel, series or a combination of both. The battery pack is also detachable, which can be replaceable or interchangeable with other battery packs such as a residential unit that can provide energy to the residence.

The battery optimization equalization management system 620 also connects and communicates with the system management 650 where the mobile charging apparatus 690 is being controlled. The system management 650 starts and stops the mobile charging apparatus 690, processes all signals, commands, and communicates with the electric vehicle 680 thru the discharging interface 670. The system management 650 may control an information indicator 640 and communications array 660. The information indicator 640 is primarily used to display information and may receive user commands. The information displayed may consist of information about the batteries 630, charge and discharge rate, temperature, point of sale information and may include a LCD, LED, touch screen, buttons, switches or other interface devices. The communications array 660 contains hardware and software used to transmit and receive information. This information may include GPS location, cellular signals, usage information, point of sale information, and information related to the function of the invention. The system management 650 sends and receives information from the discharging interface 670 and controls the power flow from the batteries 630 to the discharging interface 670 where the power flows to the electric vehicles 680. The discharging interface 670 may consist of a cable or connector to the electric vehicle 680, can transmit or receive power and signals from the electric vehicle 680.

In operation, the mobile charging apparatus 690 is charged first with the power from the power grid 600. The end user connects the mobile charging apparatus 690 to the power grid 600 through the interface to power grid 610 with the usage of a cable or a charger. The battery optimization equalization management system 620 receives the electricity from the interface to power grid 610 and transmits the electricity to the batteries 630 if the incoming voltage is DC; or first converts the electricity to DC if the electricity from the interface to power grid 610 is AC. During the whole charge and discharge process, the battery management system 620 monitors the batteries 630 and provides information to the system management 650. The system management 650 transmits all the information related to the function, battery status and point of sale information to the information indicator 640, where the end user can see the status of the charge or if there is an error or warnings. The system management 650 also sends data to the communications array 660, where the end user may receive information on their computer or mobile device. In the event of a sale, the communications array 660 is capable of transmitting and receiving the point of sale information to complete a transaction between the end users credit card and the provider. The system management 650 communicates with the electric vehicle 680 thru the discharging interface 670 and controls the start/stop of the flow of electricity from the batteries 630 to the electric vehicle 680.

The aforementioned battery optimization, equalization management system (BOEMS) as described in FIGS. 1-5 may be applied to the battery management system 620 for optimization, equalization of the battery cells within the batteries 630.

In some embodiment, the mobile charging apparatus 690 is big enough to contain batteries 630 that are capable of storing enough electricity to charge or extend the range of an electric vehicle 680. The mobile charging apparatus 690 may have enough room internally to house the system management 650, communications array 660, battery management system 620 and additional space to cool the batteries 630. In some embodiment, the mobile charging apparatus can be used as an energy storage and energy source for residential, commercial and industrial applications. Where the batteries 630 are interchangeable and detachable to increase or decrease the storage capability as needed for each application.

In residential areas where single family dwellings are not available and most residents reside in high rise skyscrapers, the electric vehicle owner will not be able to recharge the electric vehicle with convenience. One of the few practical options would be to utilize public charging stations. However, in metropolitan areas public charging stations close to residential areas will be difficult to find. Without the coverage of electric vehicle charge stations and the inability to charge at home for metropolitan areas the demand for electric vehicles will dramatically decrease.

A mobile charging apparatus for electric vehicles provides the convenience, mobility and support of charging electric vehicles without the power grid infrastructure, the installation of electric vehicle chargers and the limited availability of electric vehicle charge stations.

The mobile charging apparatus may receive electrical energy from the power grid and store the electricity into the on board battery pack, then transfer the stored energy from the on board battery pack to the electric vehicle. The on-board battery pack may comprise a plurality of battery cells for desired energy storage and voltage specification in vehicle charging. The aforementioned battery management system may be perfectly applied for such application by ensuring each individual battery cell charged equally and monitoring each battery cell during the whole charge and discharge cycle.

In one embodiment, the system management unit is the main controller, containing all software, firmware, signals processing, emergency shut off, payment, sales, and usage information. The communication array receives data from the system management unit and the electrical vehicle, the communication array also provides GPS information and provides charging, sales, payment, usage information to the back end office or the end user.

In one embodiment, the charging apparatus may also work in reverse during a power outage or power failure, where it can provide electricity back to the power grid, residence or commercial building. When operating in reverse the apparatus can provide power from its internal batteries, or receive electricity from the electric vehicle and to act as a backup generator,

The mobile charging apparatus provides charging to the electric vehicle without the electric vehicle charging infrastructure in place. The electric vehicle can be recharged anywhere with access to the power grid and saves on the cost and installation time for putting in the charging infrastructure.

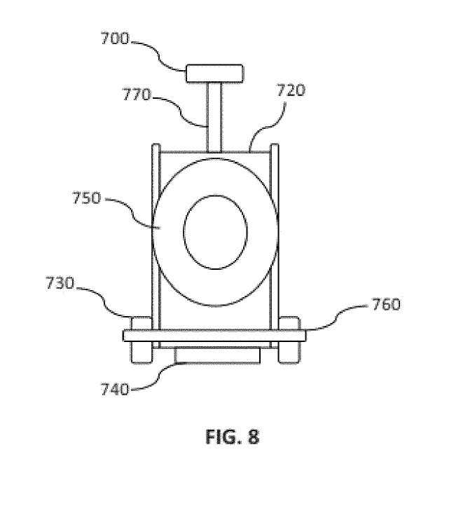

FIG. 7 is a perspective view of a mobile charging apparatus in accordance with an embodiment of the present invention. FIG. 8 is a front view of a mobile charging apparatus of FIG. 7.

Referring now to FIG. 7 and FIG. 8, there is shown a perspective view of a mobile charging apparatus 720 from the side and from the front respectively. The mobile charging apparatus 720 is shown to stand upright, supported by a set of wheels 730 and a horizontal stopper 740. The wheels 730 are used to help transport the mobile charging apparatus 720 to the electric vehicle and to be charged off of the power grid. The horizontal stopper 740 is used to help the mobile charging apparatus 720 to stand upright. The bump protection 760 is used to protect the mobile charging apparatus 720 and the electric vehicle during transportation and moving into position to charge the electric vehicle. Information indicator 710 is positioned on the housing of the mobile charging apparatus 720 to display information and receive commands from the end user. Interface to electric vehicle 750 is shown to be a cable coil to connect with the electric vehicle. The coil can be wrapped around and stored with the mobile charging apparatus 720. To easy the movement of transporting the mobile charging apparatus 720, extension bar 770 and extendable handle 700 is attached to the mobile charging apparatus 720.

The construction details of the invention as shown in FIG. 7 and FIG. 8, are that the mobile charging apparatus 720 can have an outer housing made of plastic or any other sufficiently rigid and strong material such as high-strength plastic, metal, wood, and the like. The batteries within the mobile charging apparatus can be of any high efficiency battery storage material, which can provide enough stored electricity to provide a charge to the electric vehicle.

The advantages of the present invention include, without limitation, the portability to provide power to an electric vehicle with the electricity from the power grid and to extend the range of an electric vehicle. This capability is crucial for areas without electric vehicle charging infrastructure and without the private parking of a single-family dwelling. The present invention is also capable of acting as an energy storage device and provide power to businesses, residences and industrial sites. With removable battery packs to be shared with portable battery packs used to charge electric vehicles.

At present, the power source of large-scale charging facilities in commercial and industrial areas are three-phase AC output terminal of standard distribution transformer which is taken from the public power distribution network. (e.g. Three-phase four-wire power line at 280V or 480V).

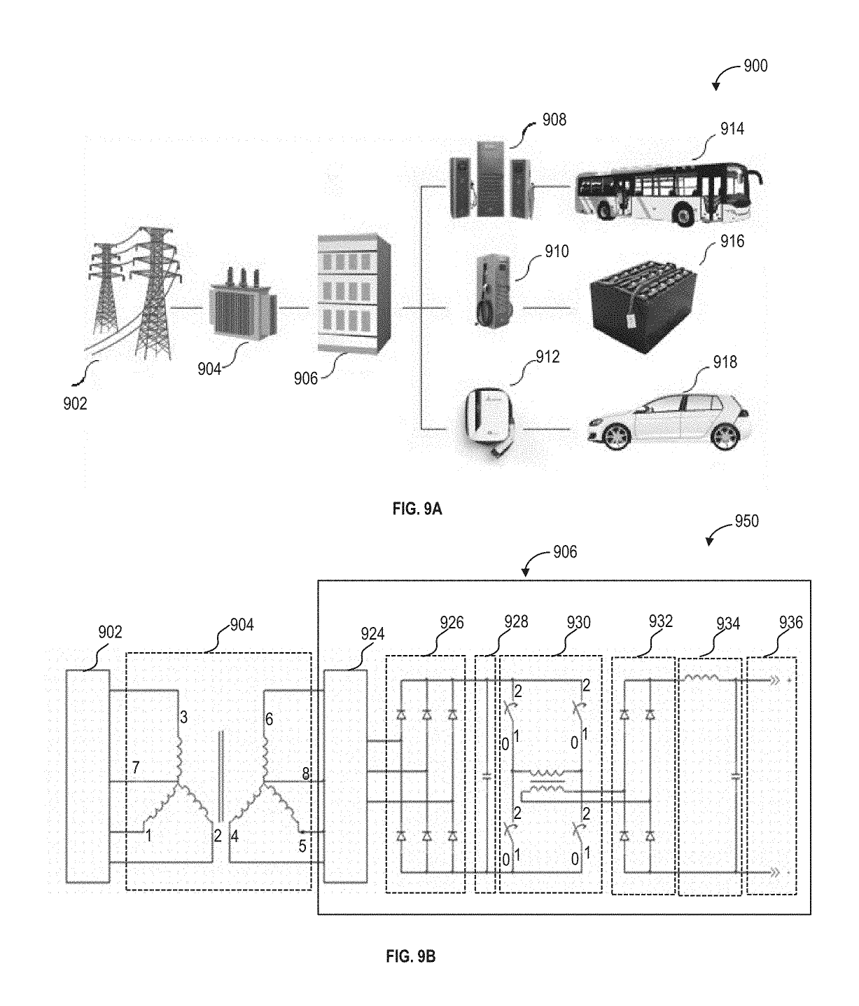

The current industry practice is to utilize high frequency switching power supplies and inverter technology to transform the public power distribution network into a controllable DC power supply, as shown in FIGS. 9A and 9B. Turning to FIG. 9A, a schematic diagram of a charging station 900 is shown. Power lines or grid 902 supply electricity needed by the charging station 900. As an example, the power lines 902 may include high voltage three phase AC 240 V or 480 V in the U.S. and 380 V in other countries like China. The electricity supplied from the power lines 902 is connected to a transformer 904 where the input from the power grid 902 is converted from high voltage AC to low voltage AC. The low voltage AC from the transformer 904 is then further converted to DC voltage by a converter 906 and the DC voltage output of the converter 906 may be used by other chargers 908, 910, 912. In another variation, components from converter 906 may be included in other chargers 908, 910, 912, and does not need to be in duplicate locations, thus leading to the various sizes of the chargers 908, 910, 912. Herein, an output from the chargers 901, 910, 912 may be used to charge buses 914, battery packs 916, and/or electric vehicles 918, for example.

In further detail, transformer 904 converts the high voltage AC into low voltage AC and the converter 906 converts the low voltage AC into DC voltage. Converter 906 provides the high frequency AC inverter isolation and then rectifies the AC to be converted to the DC voltage needed by the chargers (908, 910, 912). Present charging systems use multiple stages within the converter 906 to convert from AC to DC and isolate the AC as shown in FIG. 9B.

In FIG. 9B, a high-level schematic 950 of the converter 906 for the charging station 900 is shown. The transformer 904 may be a three-phase transformer that converts the high voltage AC from the power grid 902 to low voltage AC. In order to use the three-phase transformer 904 with the electric vehicle charging requirements, the converter 906 subjects the output of the transformer 904 (e.g. three-phase four-wire standard AC) to a variety of power transformations such as reducing harmonic interference, reducing power factor, and isolation. Herein, due to the cost, technical specification requirements, reliability, and maintainability of the various aspects of the current industry method, the converter 906 may include multiple single-phase AC and DC power modules to meet the technical requirements of the DC output for charging. The multiple stages of the converter 906 results in making the whole charging station design cumbersome, high in cost, and takes up a lot of real estate at the installation site, as discussed below.

As shown in FIG. 9B, the converter 906 may include a filter 924, which filters the low voltage AC and reduces harmonic interference from the power grid 902. The filter 924 may be an active filter or a passive filter that is used to maintain a low power factor in order to reduce the harmonic interference with the power grid. As such, active filters have low power factors, but have low reliability and high cost, whereas passive filters are low cost but are huge in size and can be extremely heavy. In some examples, the filter 924, may not be included in the converter to save cost and space.

After filtering, the AC output is converted to DC using rectifiers 926 and further filtered by a filter 928 to prevent harmonics and provide isolation. In a non-limiting example, the filter 928 may be a DC ripple filter or a low pass filter. The converted DC voltage is then put thru a high frequency DC to DC transformer 930 to be isolated from the grid and provide additional electrical isolation. The final high frequency DC output is then further rectified 932 and filtered 934 before the DC output 936 is suitable for charging an electric vehicle or battery-operated devices.

Since the converter 906 includes multiple stages, there are many points associated with the multiple stages where faults can occur, which makes the charging station 900 difficult to service and maintain. Due to the large number of components used in the multiple stages of converter 906, risk of component failure is high, which adversely affecting the reliability of the charging station 900. In addition, at each stage of the converter, there are losses, which decreases the overall efficiency of the charging station. Thus, the whole design of the charging station 900 is cumbersome, high in cost, taking up a lot of real estate at the installation site, with many fault points making it difficult to maintain. The system wide efficiency is very low, and in order to correct the power factor from the three-phase power grid, it is necessary to spend nearly half of the design and material cost in the inverter system to do power factor correction and harmonic control.

To overcome the cost, reliability, maintenance, and efficiency issues of the charging system 900 of FIGS. 9A and 9B, a charging system or station 1000 of the present invention includes a first stage filter and a multi-phase rectifier transformer as shown in FIGS. 10A and 10B. The electricity supplied from the power grid 902 is filtered and converted into a DC voltage using a converter 1010. The converter 1010 may be a non-limiting example of the converter 36 shown in FIG. 1. Herein, the converter 1010 includes a filter 1002, a multi-phase rectifier transformer 1004, and a multi-pulse rectifier 1006 that converts the high voltage AC from the power grid into a DC voltage that can be used by a DC charger 1008, for example. Herein, the filter 1002 is downstream of the power grid 902 and directly coupled to the power grid 902. Further, the filter is upstream of the multi-phase rectifier transformer 1004, and delivers filtered high voltage AC to the transformer 1004.

In some embodiments, the filter 1002 may be used for filtering AC harmonics. In one embodiment, the filter 1002 may be an LC filter which reduces the harmonic pollution to and from the power grid 902. Based on the requirements of the local power company, the inductive (L) and capacitive (C) components of the filter 1002 can be targeted and utilized in multiple sets to eliminate a specific number of harmonics and resonance frequencies to and from the power grid 902. In some example embodiments, the LC selection may be based on the required harmonic filtering needed shown in equation (1):

f=1/((2pi)(LC)̂(−1/2)) (1)

The inclusion of the filters before or after the transformer is based on cost and space requirements. When included before the transformer, the filter is a high voltage AC filter, which includes smaller and lower cost components. When included after the transformer, the filter is a low voltage AC filter, which includes larger and higher cost components. Filter 1002 is a high voltage AC filter used for filtering AC harmonics, and is smaller in size, takes up less space/real estate, and is lower cost, whereas, filter 924 is a low voltage AC filter and filter 928 is a DC ripple filter or low pass filter, which are high cost, larger in size, and take up a larger space/real estate.

The high voltage AC input from the power grid 902 is filtered using the filter 1002 and fed into the multi-phase rectifier transformer 1004. The multi-pulse rectifier transformer 1004 may be designed for low harmonic rectification having six or more phases. The multi-phase rectifier transformer 1004 converts the high voltage AC into low voltage multi-phase AC. In a non-limiting embodiment, the multi-phase transformer 1002 may include a six phase transformer, as shown in FIG. 10B, Next, the low voltage multi-phase AC is passed to a multi-pulse rectification and filtering device 1006 and converted to DC which is used by a non-isolated DC charger 1008. For a six-phase transformer shown in FIG. 10B, 12-pulse rectifier 1006 is used. Herein, the six phase transformer includes a Y transformer 1014 and a delta transformer 1016. As such, the multi-phase rectifier transformer 1004 has the capability for electrical grid isolation, voltage level transformation, and multi-voltage phase change.

In some examples, instead of using a six-phase transformer, a nine-phase, or a twelve-or more phase transformers may be used. With a nine-phase transformer, 18-pulse rectifier is needed, and for a twelve-phase transformer, 24-pulse rectifier is needed, and so on. With the increase in the number of phase transformers the harmonic isolation also improves, at the same time increasing cost and real estate of the installation. In some embodiments, the six-phase transformer may include at east one set of Y and at least one set of delta transformers.

The output from the rectifier transformer 1004 is a low voltage multi-phase AC voltage and is passed thru multi-pulse rectifier 1006 and converted to DC voltage. More specifically, the output of the converter 1010 is a DC voltage that can be directly used by non-isolated DC chargers 1008 to charge electric vehicles. In this way, the high voltage AC from the power grid 906 may be converted to DC voltage using the converter 1010 which uses fewer components (compare components of 906 and 1010). The use of multi-phase rectifier transformer 1004 is a passive solution which does not require contractive response, maintenance or change in its setting, and is considered fail safe with almost no maintenance needed. The DC voltage generated by the converter 1010 has a power factor range of about 0.97 to 0.99, which is higher than the industry-standard three phase four wire transformers (which is about 0.95). This new design provides a power factor correction, and reduces the harmonic interference drastically. In this way, the charging station using the converter 1010 is lower in cost, a more efficient charging station for charge Electric Vehicles and battery packs, and more reliable.

The industry-standard charging station design shown in FIGS. 9A-9B can achieve a maximum of 91% efficiency even after using extremely high cost components which are typically very heavy and bulky. However, the charging stations using the converter 1010 of the present invention can easily achieve 95% efficiency (even with cheaper components), have lower cost, light weight and includes significant space savings. For example, the space used by converter 1010 is about 80% lesser than the space used by the DC converter 906 of FIG. 9A.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the below claims are solely for ease of examination of this patent application, and are exemplary, and are not intended in any way to limit the scope of the claims to the particular features having the corresponding reference numbers in the drawings. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

What is claimed:

1. A battery management system to provide optimization and equalization management for a battery containing a plurality of individual battery cells (12), the system (620) comprising:
a plurality of battery cell controllers (20) each comprising a controllable switch (22), with each battery cell controller (20) electrically and conductively coupled to an individual battery cell (12) via the controllable switch (22);
a master controller (30), electrically and conductively coupled to each of the plurality of battery cell controllers (20) for performing one or more of charging, discharging, optimization, and equalization of the plurality of individual battery cells (12);
a power source (32) operatively coupled to the master controller (30) for supplying a charging current to the plurality of individual battery cells (12) via the plurality of battery cell controllers (20); and
a load (34) operatively coupled to the master controller (30) for receiving electrical energy from the plurality of individual battery cells (12),
wherein each battery cell controller (20) measures a charge level of the individual battery cell to which it is coupled and transmits said measures to the master controller (30), wherein if the master controller (30) determines that the individual battery cell is at full capacity based on the charge level, then the charging current is shunted away from the individual battery cell or a trickle charging is provided to the individual battery cell to maintain the charge level at full capacity,
wherein the trickle charging is implemented by controlling an ON/OFF duty cycle of the controllable switch to supply a desired trickle charging current to the individual battery cell determined to be at full capacity.

2. The battery management system of claim 1, wherein the power source (32) comprises a power grid (902) and the load (32) comprises an electric vehicle, an industrial electric vehicle, an electric bus, a portable battery pack, and/or a battery operated vehicle, and wherein the master controller (30) is further coupled to a converter (36) that converts high voltage AC output from the power grid (902) into a DC voltage for charging the plurality of individual battery cells (12) to sufficiently charge the load (32), wherein the converter (32) includes a filter and a multi-phase rectifier transformer for reliably and efficiently converting the high voltage AC into the DC voltage, which is subsequently used to charge the electric vehicle, industrial electric vehicle, electric bus, portable battery pack, and/or battery operated vehicle.

3. The battery management system of claim 2, wherein filter (1002) comprises an inductor-capacitor (“LC”) filter, wherein inductor and capacitor components of the LC filter are targeted to eliminate a specific number of harmonics and resonance frequencies of the power grid.

4. The battery management system of claim 2, wherein the multi-phase rectifier transformer (1004) is coupled to a multi-pulse rectifier (1006), wherein the multi-phase rectifier transformer converts the high voltage AC into a multi-phase AC, and wherein the multi-pulse rectifier that converts the multi-phase AC into the DC voltage.

5. The battery management system of claim 4, wherein the multi-phase rectifier transformer (1004) comprises a six-phase, nine-phase, or twelve-phase transformer coupled to respective twelve-pulse, eighteen-pulse, or twenty-four-pulse rectifier (1006).

6. The battery management system of claim 1, wherein the individual battery cell (12) is a Lithium battery cell, Lithium-ion battery cell, Lithium polymer battery cell, electrolytic battery cell or electrochemical battery cell.

7. The battery management system of claim 1, wherein the master controller (30) receives an input from each battery cell controller and generates an output for each battery cell controller based at least on the input from each battery cell controller, wherein the input from each battery cell controller comprises at least one of a voltage across the electrically and conductively coupled individual battery cell, a current through the electrically and conductively coupled individual battery cell and a temperature of the electrically and conductively coupled individual battery cell.

8. The battery management system of claim 7, wherein the master controller (30) generates an output for each battery cell controller based on a comparison between the voltage across each electrically and conductively coupled individual battery cell and a first voltage range.

9. The battery management system of claim 7, wherein the master controller (30) generates an output for each battery cell controller based on a comparison between the temperature of the electrically and conductively coupled individual battery cell and a temperature range.

10. The battery management system of claim 7, wherein the master controller (30) generates an output for each battery cell controller further based on a comparison between the voltages across each individual battery cell and an average voltage of the plurality battery cells.

11. The battery management system of claim 1, wherein the charging current is shunted away from the individual battery cell determined to be at full capacity by switching OFF the controllable switch coupled to the individual battery cell determined to be at full capacity.

12. The battery management system of claim 1, wherein when the plurality of battery cells (12) is not at full capacity, being charged, or discharging, the mater controller (30) communicates with each battery cell controller to perform equalization of the charge level of the plurality of battery cells to a common charge level, wherein trickle charging maintains the charge level of each battery cell at the common charge level.

13. A rechargeable battery pack comprising:
a plurality of individual battery cells (12);
a plurality of battery cell controllers (20), each battery cell controller coupling to an individual battery cell (12);
a master controller (30) coupling a power source (32) and a load (34) to each of the plurality of battery cell controllers (20), wherein each battery cell controller is controlled by the master controller (30) to engage or disengage each coupled individual battery cell (12).

14. The rechargeable battery pack of claim 13, wherein the power source (32) is a power grid (902), and the master controller (30) couples the power grid (902) to each of the plurality of battery cell controllers (20) via a converter (36), wherein the converter (36) converts high voltage AC input from the power grid to DC voltage, and wherein the converter (36) includes a filter (1002) that removes harmonic interference from the high voltage AC input and further includes a multi-phase rectifier transformer (1004) that efficiently and reliably converts filtered high voltage AC into the DC voltage for charging the rechargeable battery pack.

15. The rechargeable battery pack of claim 14, wherein the filter (1002) is downstream of the power grid (902) and upstream of the multi-phase rectifier transformer (1004), and wherein the filter comprises an inductor-capacitor (“LC”) filter, wherein inductor and capacitor components of the LC filter are targeted to eliminate a specific number of harmonics and resonance frequencies of the power grid.

16. The rechargeable battery pack of claim 15, wherein the multi-phase rectifier transformer (1004) is coupled to a multi-pulse rectifier (1006), wherein the multi-phase rectifier transformer (1004) converts the high voltage AC into a multi-phase AC, and wherein the multi-pulse rectifier (1006) that converts the multi-phase AC into the DC voltage.

17. The rechargeable battery pack of claim 16, wherein the multi-phase rectifier transformer (1004) comprises a six-phase, nine-phase, or twelve-phase transformer coupled to respective twelve-pulse, eighteen-pulse, or twenty-four-pulse rectifier (1006).

18. A cost-effective electric vehicle charging system (1000) for reliably and efficiently charging an electric vehicle (1012), the system comprising:
a converter (1010) coupling a power grid (902) to the electric vehicle (1012), the converter (1010) having an inductor-capacitor (“LC”) filter (1002), a multi-phase rectifier transformer (1004), and a multi-pulse rectifier (1006) that effectively filters and reduces harmonics from the power grid (902) and further converts high voltage input AC voltage into DC voltage; and
a DC charger (1008) coupled to the converter (1010) that receives the DC voltage and applies the DC voltage to the electric vehicle (1012) for charging the electric vehicle
wherein inductor and capacitor components of the LC filter (1002) are targeted to eliminate a specific number of harmonics and resonance frequencies of the power grid, to effectively reduce harmonic pollution from the high voltage AC voltage of the power grid.

19. The cost-effective electric vehicle charging system of claim 18, wherein the multi-phase rectifier transformer (1004) comprises a six-phase, nine-phase, or twelve-phase transformer coupled to respective twelve-pulse, eighteen-pulse, or twenty-four-pulse rectifier (1006).

20. The cost-effective electric vehicle charging system of claim 18, further comprising a rechargeable battery pack, wherein the rechargeable battery pack comprises a plurality of individual battery cell (12), a plurality of battery cell controllers (20), a master controller (30), wherein each battery cell controller (20) couples the master controller (30) to each individual battery cell (12), and wherein the master controller (30) couples the power grid (902) to each individual battery cell (12) through the converter (1012) to efficiently charge each individual battery cell (12) and further couples each individual battery cell (12) to the electric vehicle (1012) for reliably supplying electric energy from each individual battery cell to the electric vehicle (1012) for subsequently charging the electric vehicle (1012).
